(19) United States
(12) Patent Application Publication
(10) Pub. No.: US 2012/0076371 A1
(43) Pub. Date: Mar. 29, 2012

(54) Phantom Identification

(75) Inventors: James Frank Caruba, Bartlett, IL (US); Ralf Ladebeck, Erlangen (DE)

(73) Assignees: SIEMENS AKTIENGESELLSCHAFT, Munchen (DE); SIEMENS MEDICAL SOLUTIONS USA, INC., Malvern, PA (US)

(21) Appl. No.: 12/888,504

(22) Filed: Sep. 23, 2010

(51) Int. Cl. G06K 9/00; G06K 19/067; G06K 19/06; G12B 13/00

(52) U.S. Cl. 382/128; 250/252.1; 235/492; 235/494

(57) ABSTRACT

The invention relates to calibration phantoms used in connection with medical imaging devices such as PET, MR, etc., and particularly in connection with hybrid systems such as MR/PET systems. In some cases, the phantoms have distinguishable, machine-readable identification features that allow the imaging system to identify them automatically, without operator intervention. In other cases, even where the phantoms do not have such distinguishable, machine-readable identification features, if the imaging system is appropriately configured with cameras and/or appropriate image analysis software, the imaging system can still identify the phantoms automatically.

### FIELD OF THE INVENTION

The present invention generally relates to the field of medical imaging, and systems for obtaining diagnostic images such as nuclear medicine images and magnetic resonance (MR) images. In particular, the present invention relates to phantoms used to calibrate medical imaging systems and methods for doing so.

### BACKGROUND OF THE INVENTION

Nuclear medicine is a unique medical specialty wherein radiation is used to acquire images which show the function and anatomy of organs, bones, or tissues of the body. Radiopharmaceuticals are introduced into the body, either by injection or ingestion, and are attracted to specific organs, bones, or tissues of interest. Such radiopharmaceuticals produce gamma photon emissions which emanate from the body and are captured by a scintillation crystal, with which the photons interact to produce flashes of light or “events.” Events are detected by an array of photodetectors, such as photomultiplier tubes, and their spatial locations or positions are calculated and stored. In this way, an image of the organ or tissue under study is created from detection of the distribution of the radioisotopes in the body.

One particular nuclear medicine imaging technique is known as Positron Emission Tomography, or PET. PET is used to produce images for diagnosing the biochemistry or physiology of a specific organ, tumor, or other metabolically active site. Measurement of the tissue concentration of a positron emitting radionuclide is based on coincidence detection of the two gamma photons arising from positron annihilation. When a positron is annihilated by an electron, two 511 keV gamma photons are simultaneously produced and travel in approximately opposite directions. Gamma photons produced by an annihilation event can be detected by a pair of oppositely disposed radiation detectors capable of producing a signal in response to the interaction of the gamma photons with a scintillation crystal. Annihilation events are typically identified by a time coincidence between the detection of the two 511 keV gamma photons in the two oppositely disposed detectors, i.e., the gamma photon emissions are detected virtually simultaneously by each detector. When two oppositely disposed gamma photons each strike an oppositely disposed detector to produce a time coincidence event, they also identify a line of response, or LOR, along which the annihilation event has occurred.

An example of a PET method and apparatus is described in U.S. Pat. No. 6,858,847, which patent is incorporated herein by reference in its entirety. After being sorted into parallel projections, the LORs defined by the coincidence events are used to reconstruct a three-dimensional distribution of the positron-emitting radionuclide within the patient. PET is particularly useful in obtaining images that reveal bioprocesses, e.g., the functioning of bodily organs such as the heart, brain, lungs, etc., and bodily tissues and structures such as the circulatory system.

On the other hand, Magnetic Resonance Imaging (MRI) is primarily used for obtaining high quality, high resolution anatomical and structural images of the body. MRI is based on the absorption and emission of energy in the radio frequency range primarily by the hydrogen nuclei of the atoms of the body and the spatial variations in the phase and frequency of the radio frequency energy being absorbed and emitted by the imaged object. The major components of an MRI imager include a cylindrical magnet; gradient coils within the magnet; an RF coil within the gradient coil; and an RF shield that prevents the high-power RE pulses from radiating outside of the MR imager and keeps extraneous RF signals from being detected by the imager. A patient is placed on a patient bed or table within the magnet and is surrounded by the gradient and RF coils.

The magnet produces a Bₒ magnetic field for the imaging procedure. The gradient coils produce a gradient in the Bₒ field in the X, Y, and Z directions. The RF coil produces a B₁ magnetic field necessary to rotate the spins of the nuclei by 90° or 180°. The RF coil also detects the nuclear magnetic resonance signal from the spins within the body. A radio frequency source produces a sine wave of the desired frequency.

The concept of merging PET and MR imaging modalities into a single device is generally known in the art. See, e.g., U.S. Pat. No. 4,939,464 or co-pending U.S. patent application Ser. No. 11/532,665 filed Sep. 18, 2006 (Publication Number 2007/0102641), the contents of which are incorporated herein by reference in their entirety.

Both of these imaging modalities, as well as others, require the use of phantoms for calibration and quality control or quality assurance, which should be performed regularly to ensure continued proper functioning of the scanners. (In essence, a phantom is an object with known properties, e.g., emission activity distribution, attenuation distribution, water distribution, etc., which properties are registered by a given imaging scanner.) In addition to calibration/quality control of the individual imaging modalities in a hybrid (i.e., multiple-mode) system, phantoms are used to ensure proper alignment of the various imaging modalities. Thus, for the specific example of an MR/PET hybrid imaging system, a field-of-view (FOV) alignment phantom, an MR water phantom, a PET normalization phantom, and a PET uniform phantom (at least) will be used to set up and calibrate the system.

Depending on the particular phantoms and the particular imaging modalities in connection with which they are used, the various phantoms an operator uses may be easily distinguished in some cases or, in other cases, they may be easily confused by the system operator. Therefore, because the imaging time for MR and PET (and possibly other modalities, too) is on the order of several: minutes, if the system operator selects the wrong phantom and/or calibration/quality control protocol during the calibration/QC process, the procedure will not complete successfully and substantial, valuable time for imaging with the system may be lost.

### SUMMARY OF THE INVENTION

The present invention provides for automatic recognition or identification of the various phantoms that are used to calibrate and ensure accuracy of a given imaging system, and is particularly useful—but by no means limited to—in connection with hybrid (multiple-modality) imaging systems. Most advantageously, the present invention further entails automatically initiating the appropriate calibration/quality control protocol in connection with which a give phantom is used.

Thus, in one aspect, the invention features a self-identifying phantom. In some embodiments, the self-identifying phantom includes a phantom, per se, and a distinguishable, machine-readable identification feature associated with the phantom, per se—without which identification feature the phantom, per se, could still be used to calibrate/assure image quality of the medical imaging device. Possible machine-readable features include plugs that engage the local coil ports provided on some MR imaging systems; RFID tags; and barcodes. In other embodiments, the machine-readable identification feature works in conjunction with features located on a cradle in which the phantom, per se, is supported for calibration. Examples of such features include optical-based features (e.g., light passages through the phantom or a portion of it) and contact-based or proximity-based features (e.g., switches, electrical contacts, magnets/Hall effect sensors, etc.)

In another aspect, the invention features a medical imaging system. The medical imaging system includes imaging apparatus and a stand-alone phantom-recognizing device associated with the medical imaging device—without which stand-alone phantom-recognizing device the imaging apparatus could still be used to image a patient. Possible stand-alone phantom-recognizing devices include RFID-scanners; barcode-readers; and cameras (with associated optical-image-recognition software).

In another aspect, the invention features a medical imaging system. The medical imaging system includes a medical imaging device with an operational control system and control software residing on the medical imaging system. The control software includes image-analyzing software that analyzes an image produced by the medical imaging device and that, based thereon, recognizes and identifies an object being imaged by the medical imaging system. For example, discrete locations of emissions activity can be identified even without the system being calibrated or perfectly tuned, and the position, distribution, overall shape of the distribution, etc., can be used to recognize and identify a given phantom being imaged by the system.

These and other features of the invention will be described more fully below.

### BRIEF DESCRIPTION OF THE DRAWINGS

The invention will now be described in greater detail in connection with the figures, in which:

FIGS. 1-3 are schematic illustrations of three different embodiments of a hybrid imaging system (e.g., MR/PET) constructed according to certain aspects of the invention;

FIGS. 4-6 are schematic perspective views of various embodiments of phantoms constructed in accordance with certain aspects of the invention, with FIG. 4a being a close-up view of the circled portion of FIG. 4;

FIG. 7 is a schematic front view of a phantom constructed according to the an aspect of the invention;

FIGS. 8 and 9 are schematic plan views of two different embodiments of the phantom shown in FIG. 7;

FIGS. 10-14 are schematic perspective view of various embodiments of phantoms that can be used to calibrate a (hybrid) imaging system according to certain aspects of the invention; and

FIG. 15 is a schematic illustration of an overall imagining system configured to utilize certain aspects of the invention.

### DETAILED DESCRIPTION OF EMBODIMENTS OF THE INVENTION

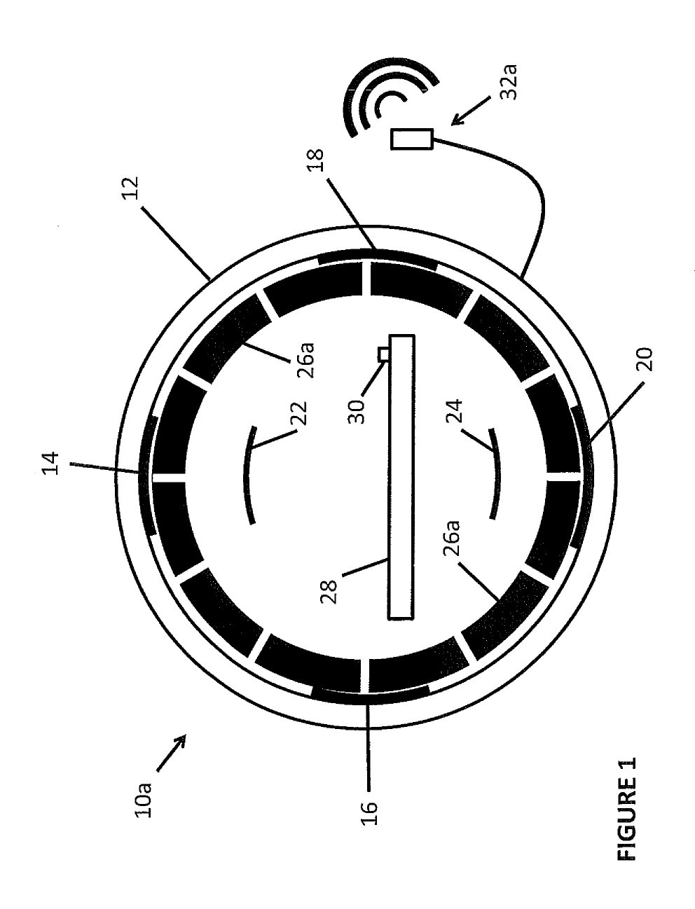

Three different embodiments 10a, lob, and 10c of a hybrid imaging system constructed according to certain aspects of the invention are illustrated in FIGS. 1, 2, and 3, respectively. Because these three embodiments are, overall, relatively similar, they will be described together, using the same reference numerals to refer to components that are the same in all three embodiments and using reference numerals that are numerically the same, but with an appended letter, to refer to components that differ among the three different embodiments but serve the same purpose.

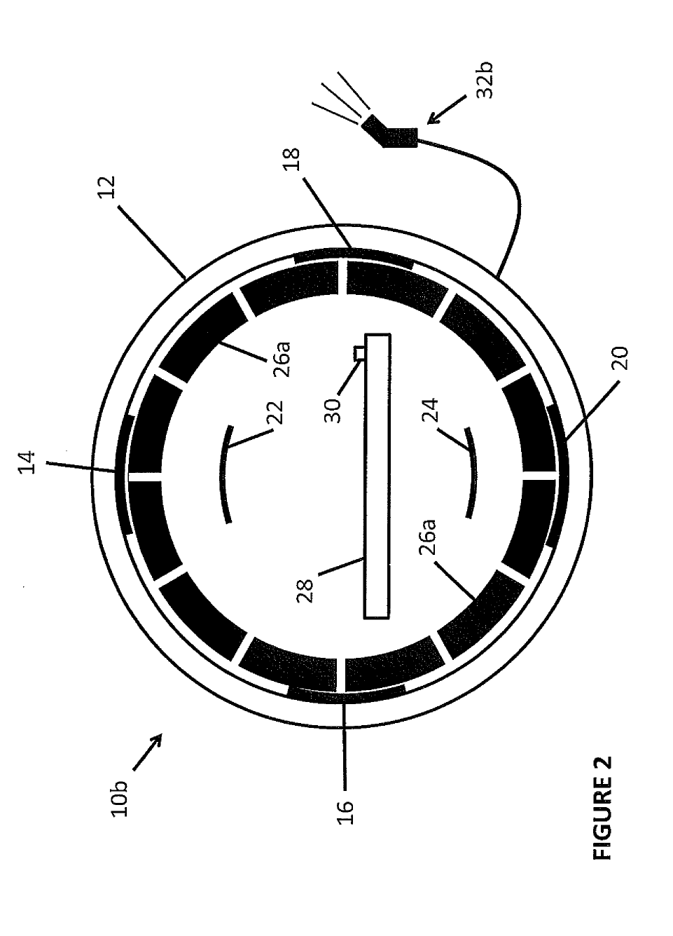

Thus, each of the hybrid imaging systems 10a, 10b, and 10c exemplarily constitutes an MR/PET imaging systems. Accordingly, each includes an MR housing 12 that houses the magnetic field-generating coils (not shown) and that supports gradient coils 14, 16, 18, and 20. Additionally, RF sensing probes 22, 24—part of the MR “half” of the hybrid system—are provided. As for the PET “half” of the hybrid system, a number of PET detectors (scintillator crystals) are provided, e.g., in the form of a ring of crystals 26a that extends circumferentially around the central, patient-receiving cavity of the systems as shown in FIGS. 1 and 2 or in the form of a pair of planar detectors 26b as shown in FIG. 2.

A patient bed 28 is centrally located centrally within the patient-receiving cavity of each of the systems 10a, 10b, and 10c. Additionally, a port 30 into which are plugged any of a variety of local coils (which are used to image specific structures from “up close”) is schematically illustrated as provided, for example, on the patient bed 28. The port 30 is used to transfer information between a local coil and the imaging system, which information—e.g., the type of local coil that has been connected to the port 30—can be used to control the imaging protocol used by the imaging system. Alternatively, the port 30 is used to transmit signals/electrical power to the connected local coil.

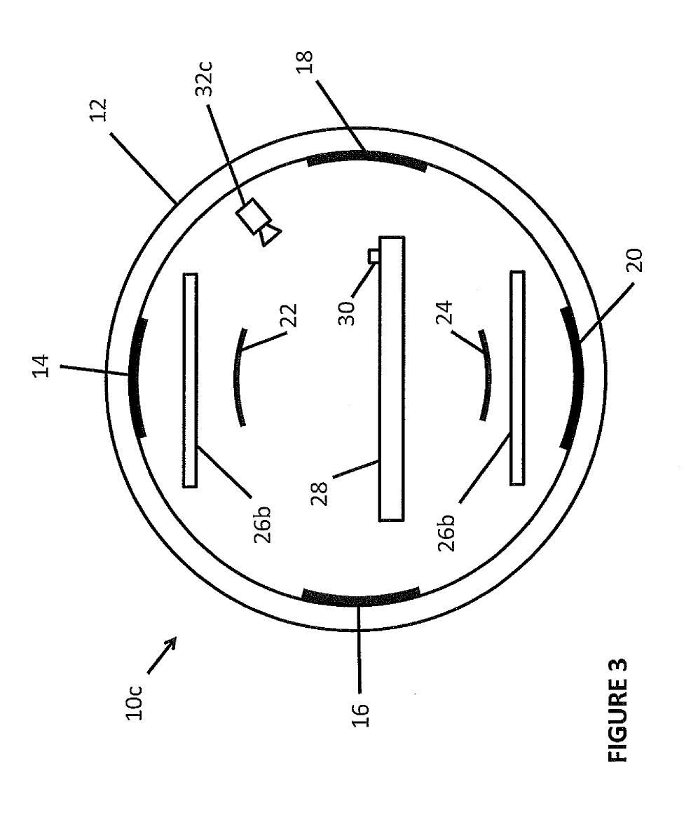

Furthermore, each of the hybrid systems 10a, 10b, and 10c is depicted as including a stand-alone phantom-recognizing device. In the embodiment 10a illustrated in FIG. 1, the stand-alone phantom-recognizing device 32a is an RFID-reader; in the embodiment 10b illustrated in FIG. 2, the stand-alone phantom-recognizing device 32b is a barcode-reader; and in the embodiment 10c illustrated in FIG. 3, the stand-alone phantom-recognizing device 32e is a camera. (As will be explained below, according to certain aspects of the invention, some “standard” features of the MR/PET systems can be used to identify the various phantoms that are placed within the system; the stand-alone phantom-recognizing devices 32a, 32b, and 32c are referred to as “stand-alone” to differentiate them from those “standard” features of the systems. Alternatively viewed, the stand-alone phantom-recognizing device is a device without which the imaging device would still be perfectly capable of functioning as such.) Depending on the phantoms to be used with the imaging system (as explained more fully below), no stand-alone phantom-recognizing device 32a, 32b, or 32c may be needed; therefore, in some cases, none wilt be present. Alternatively, it may be desirable to provide several different stand-alone phantom-recognizing devices to expand the capabilities of the imaging system. The manner in which these stand-alone phantom-recognizing devices are used, when present, will be explained more fully below.

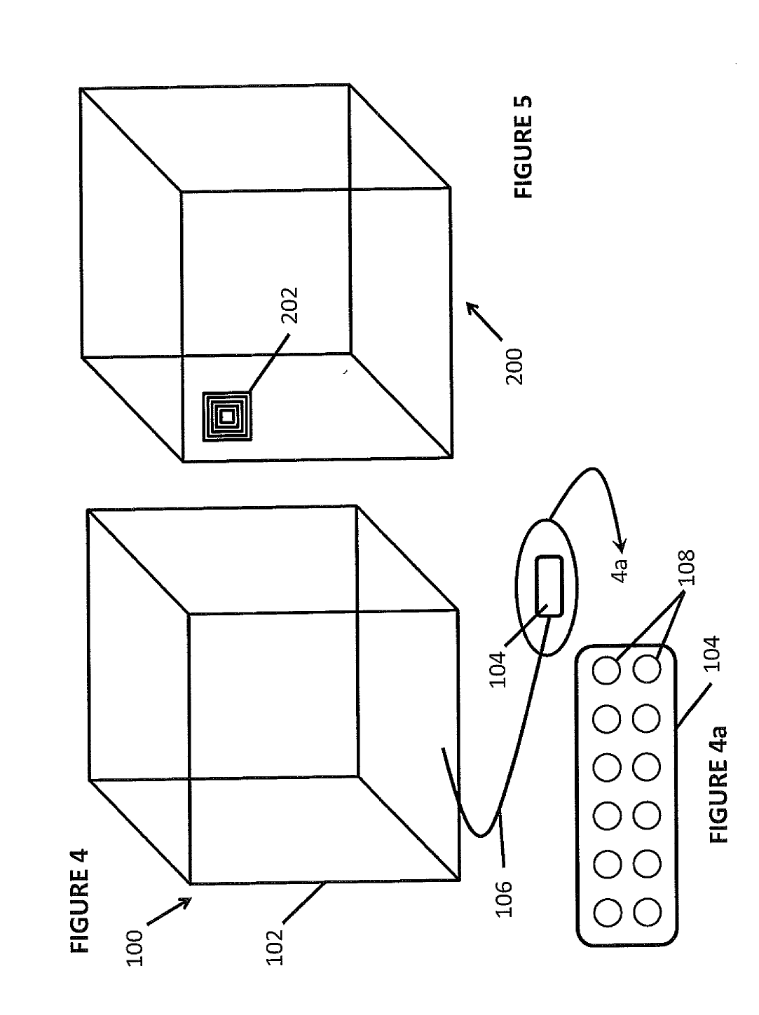

As explained above, various phantoms are used to calibrate and ensure imaging quality of an MR/PET hybrid system (as well as other single-mode or hybrid imaging systems), and according to one aspect of the present invention, the phantoms are configured to facilitate automatic identification of the phantom being used at any given time. Thus, five different exemplary embodiments of self-identifying phantoms are illustrated in FIGS. 4-9, with each of these five embodiments having a distinguishable, machine-readable identification feature associated with it. As explained below, according to certain other aspects of the invention, the overall imaging system can be configured to identify the phantom being used based on the components of the phantom that are required in order for the phantom to be useable as such, e.g., the body or matrix of the phantom, the emission-activity-providing elements, etc. Therefore, the term “distinguishable” is used to refer to machine-readable identification features that are functionally separate and apart from the phantom, per se. In other words, they are features that could be removed or eliminated from the phantom without affecting the ability of the phantom to be used as such.

In one embodiment illustrated in FIGS. 4 and 4a, a self-identifying phantom 100 includes a phantom, per se, 102 and an identification plug 104 that is attached to the phantom, per se, 102 by means of a tether 106. Advantageously, the identification plug 104 is configured to mate with the port 30 in the imaging system 10a, 10b, or 10c, with which port 30 the connector plugs on various local coils that might be used are configured to mate. As illustrated more clearly in FIG. 4a, the identification plug 104 has a number (e.g., twelve, as exemplarily illustrated) of pins and/or sockets 108 that are used to “encode” the identity of the phantom 100. Suitably, it is pins that are provided, and those pins constitute ID resistors. With a simple binary scheme, twelve pins/sockets 108 can provide 2¹², i.e., 4096, different combinations to identify the specific phantom 100 and its attributes, e.g., the type of phantom (FOV alignment, water for MR calibration, emission activity for PET calibration, etc.); specific distribution of water density (MR) or emission activity (PET); etc.

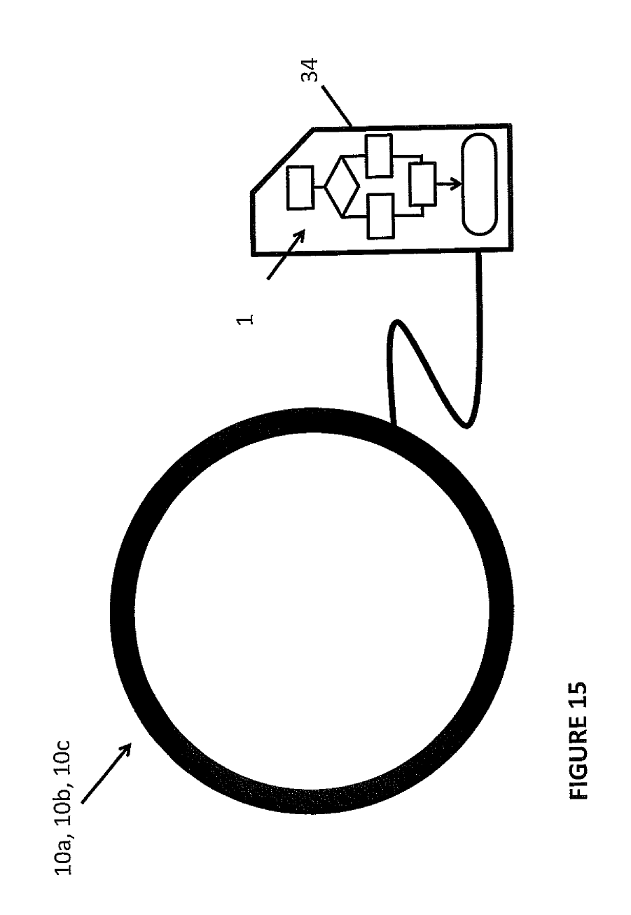

Thus, when a given phantom 100 is used to calibrate/run quality control on an imaging system, its identification plug 104 is connected to the imaging system's port 30 and the imaging system's operational control system (illustrated schematically by the flowchart 1 within the imaging system 10a's, 10b's, or 10c's control console 34 in FIG. 15) automatically detects its presence and determines its attributes (e.g., type) to the extent necessary to run a specific calibration/QC protocol. Depending on the operational control system's software 1 (which could be any appropriate combination of software, firmware, and/or physical circuits that are hard-wired to execute particular functions), the system may simply tell the operator which particular phantom has been hooked up to the system so that the operator has to select and initiate the appropriate protocol; alternatively, the system may select and initiate, either automatically after a certain delay period (for the operator to leave the imaging room) or upon an operator command, the appropriate protocol. Furthermore, it is envisioned that some calibration/QC techniques may require that various phantoms be used in a specific sequence; depending on the “intelligence” of the system, the system can be configured to alert the operator if an incorrect phantom (incorrect in terms of sequencing) has been connected to the system.

Other embodiments of self-identifying phantoms 200, 300, 400, and 500 are illustrated in FIGS. 5-9. The self-identifying phantom 200 (FIG. 5) has an RFID tag 202 located either on its surface or embedded in the phantom; an RFID-reader (e.g., RFID-reader 32a in FIG. 1) is used to read the RFID tag 202 to identify the specific phantom and its attributes and provide that information to the system, which uses that information in the same way as described immediately above. Depending on where the RFID-reader is located, its signal strength, and/or its sensitivity, it may be possible for the system to detect the presence of the phantom 200 automatically; if not, the operator will have to pass the phantom 200 past the RFID-reader before placing it in position within the system.

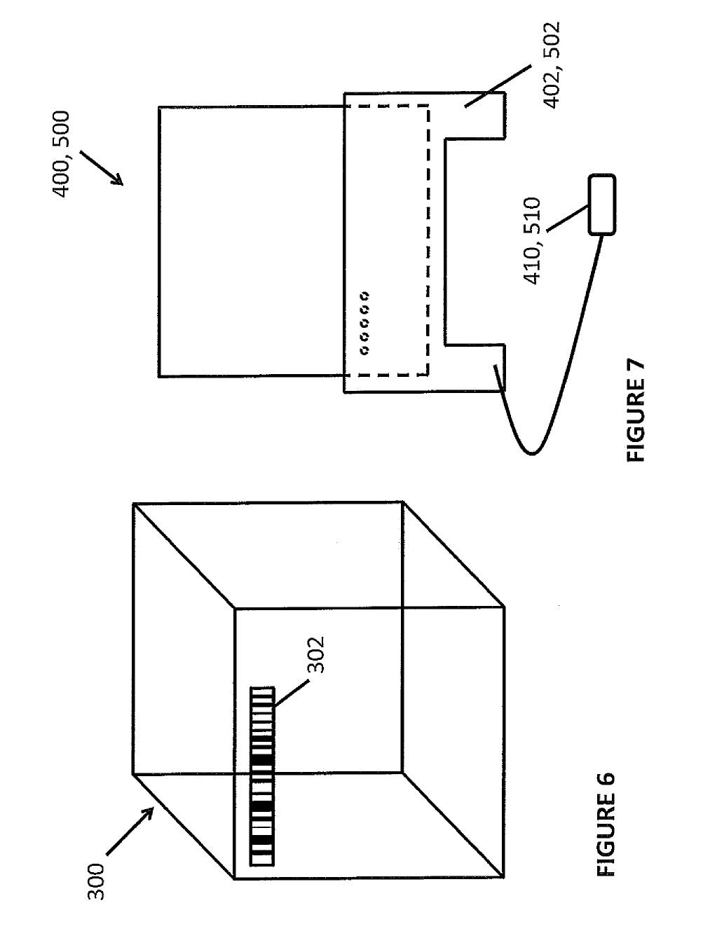

Similarly, the self-identifying phantom 300 (FIG. 6) has a barcode 302 located on its surface; a barcode-reader (e.g., barcode-reader 32b in FIG. 2) is used to read the barcode 302 to identify the specific phantom and its attributes and provide that information to the system, which uses that information in the same way as described above. Depending on where the barcode-reader is located, its laser strength, and/or its sensitivity, it may be possible for the system to detect the presence of the phantom 300 automatically; if not, the operator will have to scan the phantom 300 with the barcode-reader before placing it in position within the system.

Two further embodiments of self-identifying phantoms 400, 500 with distinguishable, machine-readable identification features associated with them are illustrated in FIGS. 7-9. As illustrated in FIG. 7, some phantoms are configured to be supported by a cradle, which holds the phantom in a specific orientation with respect to the imaging system. The phantoms 400, 500 and the cradles 402, 502 in the embodiments illustrated in FIGS. 7-9 are configured to work together to identify the phantoms to the system.

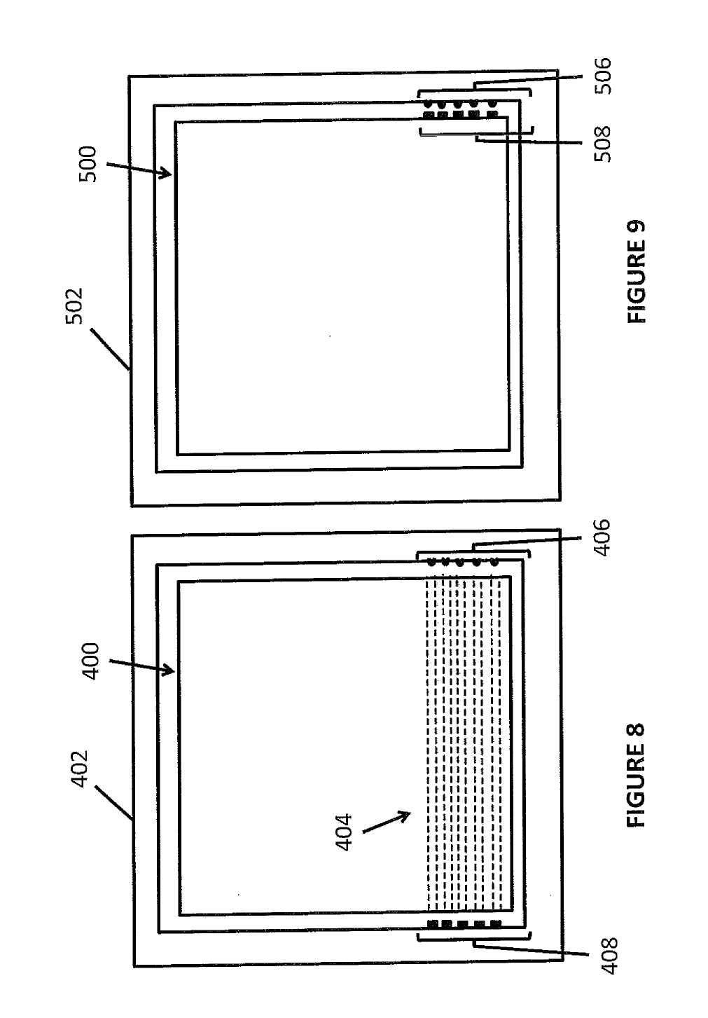

In the embodiment illustrated in FIG. 8, the self-identifying phantom 400 has a series (at least one) of passages 404 that extend through it, from one side to the other (or at least all the way through at least a portion of the phantom), and some of those passages 404 may be blocked (or even simply not formed) so as to prevent light from passing through the phantom. When the phantom 400 is placed within the cradle 402, the passages—including blocked or non-passages (i.e., where a passage is not formed at a location where it could otherwise be formed to help identify the phantom 400)—align with an array of light sources 406, e.g., LED's, that are provided on one side of the phantom 400 and a corresponding array of photodetectors or reflectors 408 that are provided on the opposite side of the phantom 400. (If reflectors are used, an appropriate light sensor is provided adjacent to each light source 406.) When the light sources 406 are illuminated; depending on whether there is an open passage in front of it, light from each of the sources 406 can activate the corresponding photodetector 408 (if photodetectors are used) or will be reflected back toward the light source (if reflectors are used) and activate the associated sensor.

Information as to the presence or absence of an open passageway at each light source location suitably is provided to the imaging system through connector 410 (FIG. 7), which, like the plug 104 attached to the phantom 100 described above, suitably mates with the imaging system's local coil port 30 to transmit that information to the imaging system. Because the information will be binary in nature, the number of different phantoms that can be identified will be 2 raised to a power equal to the number of light sources provided, e.g., 2⁵ (i.e., 32) for the illustrated embodiment. That identity information is then used to calibrate/run quality control on an imaging system as described above (including the initial determination of whether a phantom is present in the first place).

The embodiment of a self-identifying phantom 500 illustrated in FIG. 9 utilizes generally similar principles. In this case, however, instead of optical (i.e., light-based) devices, the phantom 500 utilizes at least one contact-based or proximity-based device 506 (on the cradle) and 508 (on the phantom) to identify itself to the imaging system. For example, elements 506 could be switches on the cradle 502 that are activated by protrusions 508 provided on the phantom 502; the elements 506 could be electrical contacts, which, when contacted by mating contacts 508 on the phantom 502, complete a circuit; or the elements 506 could be magnetic sensors (e.g., Hall effect sensors) that sense the presence of magnets 508 on the phantom 502. Self-identifying operation of the phantom 502, including transmission of the identifying information to the imaging system using connector 510 (FIG. 7), is otherwise the same is it is for self-identifying phantom 400.

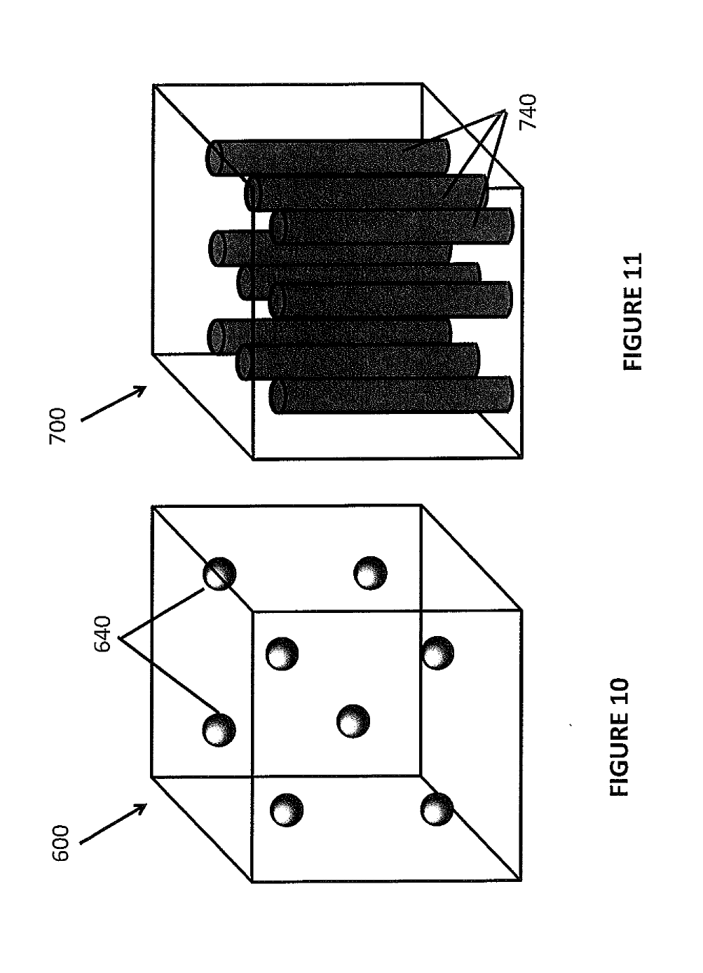

According to another aspect of the invention, in many cases, phantoms that do not have any associated distinguishable, machine-readable identification features can still be used for automatic identification. In particular, phantoms often can be distinguished visually fairly easily based on their shapes and/or dimensions. For example, as illustrated in FIGS. 10-14, phantoms might be cube-shaped (phantoms 600, 700, and 800); rectangular box-shaped (phantom 900); round cylindrical (phantom 1000); or any number of different shapes and/or sizes. Therefore, the embodiment 10c of an imaging system (FIG. 3) uses the camera 32c to obtain an optical image of the phantom (i.e., an image formed using light reflected from the phantom and passing into the camera 32). That optical image is provided to the imaging system's operational control software 1, which includes a machine vision module that is able to analyze the image and determine the shape and/or size—and hence the identity—of the phantom that has been placed on the patient table.

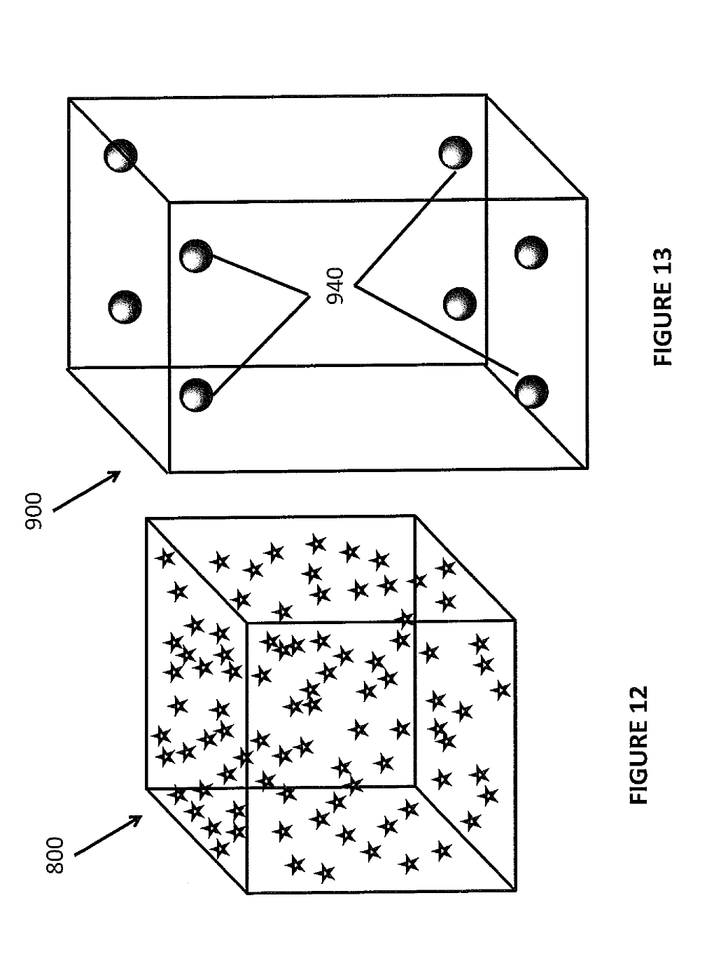

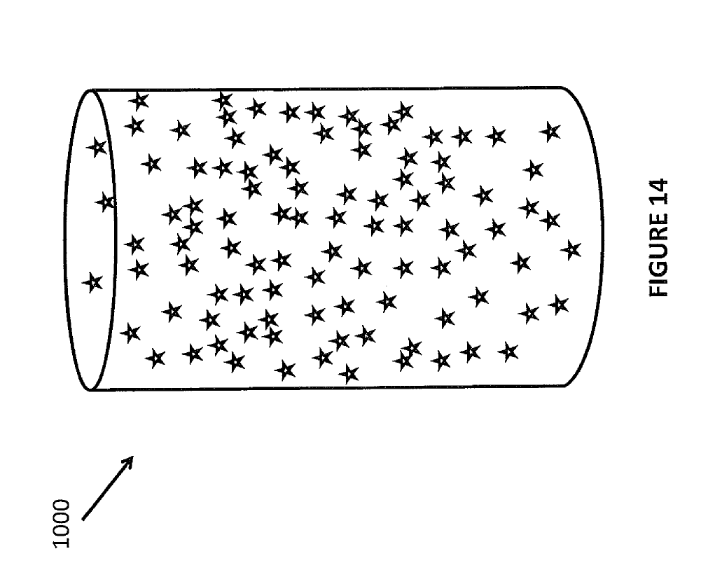

Alternatively, in many instances, the attribute of a given phantom that is detected by an imaging system and that is used to perform the calibration/quality assurance can be detected with sufficient clarity or resolution for its spatial distribution to be identified even before the imaging system has been calibrated or recalibrated. For example, emissions activity can be localized to a discrete number of spheres 640, 940, or it may be distributed throughout a predefined number and arrangement of cylindrical rods 740 that are located throughout the phantom, and the positions of those spheres/rods often can be identified sufficiently by an image analysis module within the operational control system's software 1—which module analyzes images of the phantom produced by the particular imaging mode, not an optical image of the phantom—to be able to identify the specific phantom being imaged even without the system having been calibrated or recalibrated. Alternatively, if the emissions activity is uniformly distributed throughout the phantom, as represented by the stars in FIGS. 12 and 14, then the shape of the phantom, and hence its identity, can be determined by the image analysis module.

Thus, even if specialized phantoms with distinguishable, machine-readable identification features are not used, it may be possible to identify the phantoms being used automatically (i.e., without operator intervention) so long as the imaging system, per se, is configured with appropriate image-analyzing software.

The foregoing disclosure is only intended to be exemplary of the methods and apparatus of the present invention. Departures from and modifications to the disclosed embodiments may occur to those having skill in the art. The scope of the invention is set forth in the following claims.

We claim:

1. A self-identifying phantom for use in calibrating/assuring image quality of a medical imaging device, comprising:
a phantom, per se; and
a distinguishable, machine-readable identification feature associated with the phantom, per se, without which identification feature the phantom, per se, could still be used to calibrate/assure image quality of the medical imaging device.

2. The self-identifying phantom of claim 1, wherein the identification feature comprises a plug or connector that is connected to the phantom, per se.

3. The self-identifying phantom of claim 2, wherein the medical imaging device has a port with which a plug or connector can engage to transfer information, signals, and/or electrical power between the imaging system and a device that is engaged with the port, and
wherein the plug or connector that is connected to the phantom, per se, is configured to engage with the medical imaging device's port.

4. The self-identifying phantom of claim 3, wherein the plug or connector that is connected the phantom, per se, comprises a plurality of identification resistors.

5. The self-identifying phantom of claim 1, wherein the identification feature comprises an RFID tag.

6. The self-identifying phantom of claim 1, wherein the identification feature comprises a barcode.

7. The self-identifying phantom of claim 1, wherein the self-identifying phantom is configured for registration with a support cradle and the identification feature cooperates with one or more elements on the support cradle.

8. The self-identifying phantom of claim 7, wherein the identification feature is an optical-based feature.

9. The self-identifying phantom of claim 8, wherein the identification feature comprises one or more passages that permit light to pass entirely through at least a portion of the phantom, per se.

10. The self-identifying phantom of claim 7, wherein the identification feature is a contact-based or proximity-based device.

11. The self-identifying phantom of claim 10, wherein the identification feature is a switch.

12. The self-identifying phantom of claim 10, wherein the identification feature is an electrical contact.

13. The self-identifying phantom of claim 10, wherein the identification feature is a magnet or a magnet-sensor.

14. A medical imaging system, comprising:
a medical imaging device; and
a stand-alone phantom-recognizing device associated with the medical imaging device.

15. The medical imaging system of claim 14, wherein the stand-alone phantom-recognizing device comprises an RFID-scanner.

16. The medical imaging system of claim 14, wherein the stand-alone phantom-recognizing device comprises a barcode reader.

17. The medical imaging system of claim 14, wherein the stand-alone phantom-recognizing device comprises a camera and the medical imaging system has a control system with optical-image-recognition software.

18. The medical imaging system of claim 17, wherein the medical imaging system includes a processor and the optical-image-recognition software comprises a series of instructions residing on a computer-readable medium, which instructions, when executed by the processor, are effective to cause the processor to recognize physical attributes of an object and, based on the recognized physical attributes of the object, to identify the object.

19. The medical imaging system of claim 17, wherein the optical-image-recognition software is embodied in physical circuits.

20. The medical imaging system of claim 14, wherein the medical imaging device comprises a hybrid device providing more than one medical imaging modality.

21. The medical imaging system of claim 20, wherein one of the imaging modalities is MR imaging.

22. The medical imaging system of claim 20, wherein one of the imaging modalities is PET imaging.

23. The medical imaging system of claim 20, wherein the medical imaging device is an MR/PET imaging device.

24. A medical imaging system, comprising:
a medical imaging device with an operational control system; and
control software residing on the medical imaging system and which controls operation of the medical imaging device;
wherein the control software includes image-analyzing software that analyzes an image produced by the medical imaging device and that, based on said analysis, recognizes and identifies an object being imaged by the medical imaging system as corresponding to an object previously stored in a storage medium associated with said medical imaging system.
